(19) United States
(12) Patent Application Publication
(10) Pub. No.: US 2025/0300899 A1
(43) Pub. Date: Sep. 25, 2025

(54) METHODS AND SYSTEM FOR SERVICED-BASED AI/ML MODEL TRAINING, VERIFICATION, REGISTRATION, AND DEPLOYMENT IN RAN INTELLIGENT CONTROLLERS

(71) Applicant: NEC Corporation, Tokyo (JP)

(72) Inventor: Linghang FAN, Heidelberg (DE)

(21) Appl. No.: 18/855,530

(22) PCT Filed: Apr. 12, 2023
(86) PCT No.: PCT/EP2023/059591

§ 371 Date: Oct. 9, 2024

(30) Foreign Application Priority Data
Apr. 12, 2022 (EP) 22168034.1

(51) Int. Cl. H04L 41/16; G06N 20/00

(52) U.S. Cl. CPC H04L 41/16; G06N 20/00

(57) ABSTRACT

A system for supporting artificial intelligence/machine learning (AI/ML) model functions using a service-based architecture in a radio access network (RAN) intelligent controller (RIC) is provided. The system includes a first function for managing AI/ML functions, and for exposing management and exposure services for the AI/ML functions. The system also includes a second function for providing services for deploying the AI/ML models in the at least one RIC, and a repository for storing the AI/ML models. The first function, the second function, and the repository are connected with the service-based architecture.

### CROSS REFERENCE TO RELATED APPLICATIONS

This application is a U.S. National Phase application under 35 U.S.C. § 371 of International Application No. PCT/EP2023/059591, filed on Apr. 12, 2023, and claims benefit to European Patent Application No. EP 22168034.1, filed on Apr. 12, 2022. The International Application was published in English on Oct. 19, 2023 as WO 2023/198799 A1 under PCT Article 21(2).

### FIELD

The present disclosure relates to a communication system. The disclosure has particular but not exclusive relevance to wireless communication systems and devices thereof operating according to the 3rd Generation Partnership Project (3GPP) standards or equivalents or derivatives thereof. The disclosure has particular although not exclusive relevance to the so-called ‘5G’ (or ‘Next Generation’) systems using artificial intelligence/machine learning elements.

### BACKGROUND

The O-RAN Alliance (O-RAN/ORAN) is a group that defines specifications for open radio access networks (Open RANs). The Open RAN architecture is based on a disaggregated approach to deploying RANs, that is built on cloud native principles, and represents an evolution of the Next Generation RAN (NG-RAN) architecture.

The ORAN Working Group 2 are currently defining the Non-RT RIC architecture [2], R1 interface [3] and A1 interface [4]. The ORAN Working Group 3 are currently defining the Near-RT RIC architecture [5], and E2 interface [6].

AI/ML plays a key role in the RIC. However, the specifications on AI/ML are “for further study” in [2][3]. In order to provide a workable AI/ML mechanism in the RIC, the inventors have realised that there is a need to solve the following problems, which have not been addressed in ORAN.
What AI/ML functions are needed?
Where are these AI/ML functions located?
How to implement these AI/ML functions?
What interfaces should be among these AI/ML functions?
What interfaces should be among these AI/ML functions and other non-AI/ML functions?
How to train an AI/ML model in a RIC by using AI/ML functions?
How to certify an AI/ML model in a RIC by using AI/ML functions?
How to register an AI/ML model in a RIC by using AI/ML functions?
How to deploy an AI/ML model in a RIC by using AI/ML functions?

### SUMMARY

In an embodiment, the present disclosure provides a system for supporting artificial intelligence/machine learning (AI/ML) model functions using a service-based architecture in a radio access network (RAN) intelligent controller (RIC). The system includes a first function for managing other AI/ML functions, and for exposing management and exposure services for the AI/ML functions, a second function for providing services for deploying the AI/ML models in the at least one RIC, and a repository for storing the AI/ML models. The first function, the second function, and the repository are connected with the service-based architecture.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a service-based AI/ML architecture;

FIG. 2 is a diagram showing a procedure for an AI/ML service consumer working with AL/ML functions in the RIC to model training and deployment (integrated procedure);

FIG. 3 is a diagram showing a procedure for an AI/ML model training in the RIC;

FIG. 4 is a diagram showing a procedure for an AI/ML model verification and certification in the RIC;

FIG. 5 is diagram showing a procedure for an AI/ML model registration in the RIC;

FIG. 6 is a diagram showing a procedure for an AI/ML model deployment in the RIC;

FIG. 7 is a diagram showing a procedure for an AI/ML service consumer works with AL/ML functions in the RIC to model training;

FIG. 8 is a diagram showing a procedure for an AI/ML service consumer works with AL/ML functions in the RIC to model deployment;

FIG. 9 schematically illustrates a communication system to which the above aspects are applicable;

FIG. 10 is a block diagram illustrating the main components of a UE;

FIG. 11 is a block diagram illustrating the main virtual components of an exemplary v(R)AN node; and

FIG. 12 is a block diagram illustrating the main virtual components of a core network node.

### DETAILED DESCRIPTION

### Abbreviations and Terminology

GPP 3rd Generation Partnership Project
A1 Interface between Non-RT RIC and Near-RT RIC
AI Artificial Intelligence
DMS Deployment Management Services
E2 Interface between Near-RT RIC and underlying RAN functions (O-CU, O-DU and O-RU)
EI Enrichment Information
DMS Deployment Management Services
KPI Key performance indicator
ML Machine Learning
Near-RT RIC O-RAN Near-Real-Time RAN Intelligent Controller
Non-RT RIC O-RAN Non-Real-Time RAN Intelligent Controller
O-CU O-RAN Central Unit
O-DU O-RAN Distributed Unit
O-RU O-RAN Radio Unit
O1 Interface between SMO and O-RAN managed elements
OAM Operations, Administration and Maintenance
ORAN O-RAN ALLIANCE
RAN Radio Access Network
RIC O-RAN RAN Intelligent Controller
rApp Non-RT RIC Applications
SMO Service Management and Orchestration
UE User Equipment
xApp Near-RT RIC Applications

The present invention aims to address, or at least partially ameliorate, one or more of the above problems.

In accordance with an embodiment, the present disclosure describes the following:
Solution 1: A service-based AI/ML architecture in the RIC
Solution 2: A solution on how an AI/ML service consumer works with AL/ML functions in the RIC (in one integrated procedure).
Solution 3: A solution on how to train an AI/ML model in the RIC.
Solution 4: A solution on how to certify an AI/ML model in the RIC.
Solution 5: A solution on how to register an AI/ML model in the RIC
Solution 6: A solution on how to deploy an AI/ML model in the RIC.
Solution 7: A solution on how an AI/ML service consumer works with AL/ML functions in the RIC (in separated procedures)

### Solution 1: a Service-Based AI/ML Architecture in the RIC

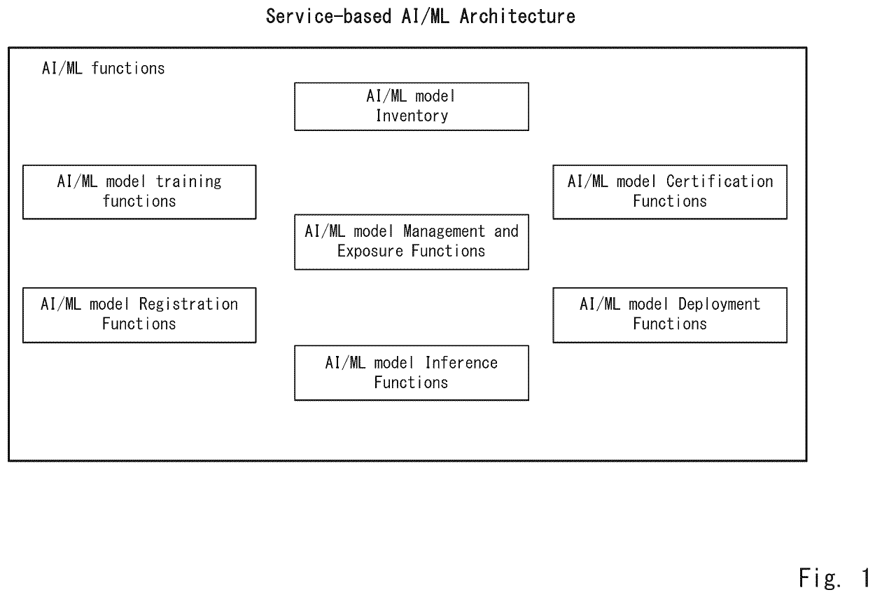

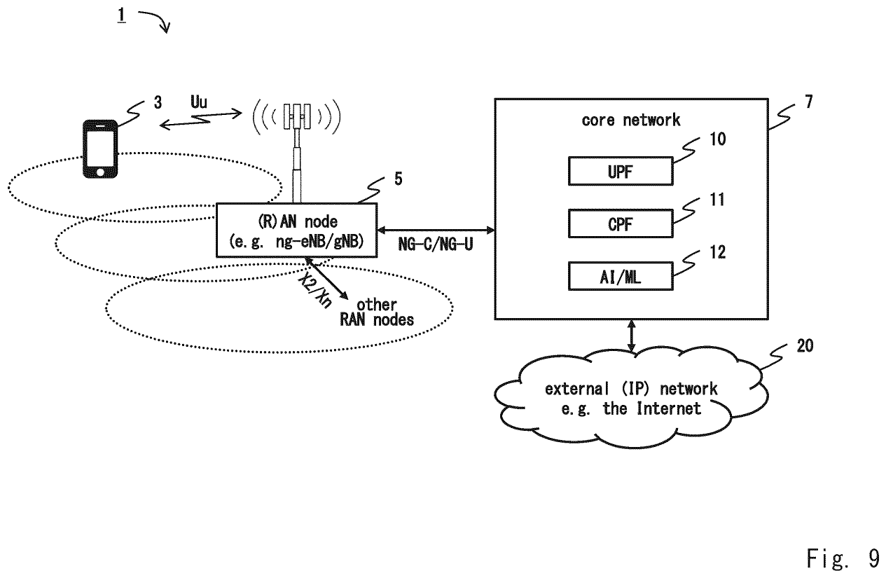

FIG. 1 illustrates schematically an exemplary Service-based AI/ML Architecture. This architecture may be implemented in the system shown in FIG. 9. All the functions in this architecture are logical functions, and each logical function provides a related service. Since several logical functions can be combined into one integrated function, which provide the combined services of all these combined logical functions, this design provides significant implementation flexibility.

The key logical functions proposed in the AI/ML functions are as follows:
AI/ML Management and Exposure functions: They are the major AI/ML functions and are responsible for managing all AI/ML functions, and exposing the management and exposure services.
AI/ML model training functions: They are AI/ML functions responsible for AI/ML model training, and provide AI/ML training services.
AI/ML model certification functions: They are AI/ML functions responsible for AI/ML model certification, and provide AI/ML certification services.
AI/ML model registration functions: They are AI/ML functions responsible for AI/ML model registration, and provide AI/ML registration services.
AI/ML model deployment functions: They are AI/ML functions responsible for AI/ML model deployment, and provide AI/ML deployment services.
AI/ML model inference functions: They are AI/ML functions responsible for AI/ML model inference, and provide AI/ML inference services. Their outputs can be analytical results.
AI/ML model Inventory: They are AI/ML functions responsible for storing AI/ML models.

Different names can be used for above functions to serve the same and similar purpose.

This serviced based AI/ML architecture enables flexible deployment scenarios including, for example:
All in the Non-RT RIC.
All in the Near-RT RIC.
Some in Non-RT RIC and some in Near-RT RIC

This serviced based AI/ML architecture enables flexible implantation options including, for example:
All logical functions implemented by SMO/Non-RT RIC Framework/Near-RT RIC Framework
All by applications.
Some by applications and some by SMO/Non-RT RIC Framework/Near-RT RIC Framework

In this disclosure, SMO/Non-RT RIC Framework/Near-RT RIC Framework means the following scenarios:
SMO
Non-RT RIC Framework
Near-RT RIC Framework
A combination of the Frameworks listed above.

It will be appreciated that the Non-RT RIC Framework is also called the Non-RT RIC platform. It will also be appreciated that the Near-RT RIC Framework is also called the Near-RT RIC platform.

### Solution 2: a Solution on How an AI/ML Service Consumer Works With AL/ML Functions in the RIC (in One Integrated Procedure)

The main idea of this solution is that an AI/ML service consumer requests the AI/ML Management and Exposure functions to perform AI/ML model training, certification, registration, and deployment. The AI/ML Management and Exposure functions instruct the related AI/ML functions to train, certify, register, and deploy one or more AI/ML models. The AI/ML Management and Exposure functions informs the AI/ML service consumer the AI/ML model training, certification, registration, and deployment result(s).

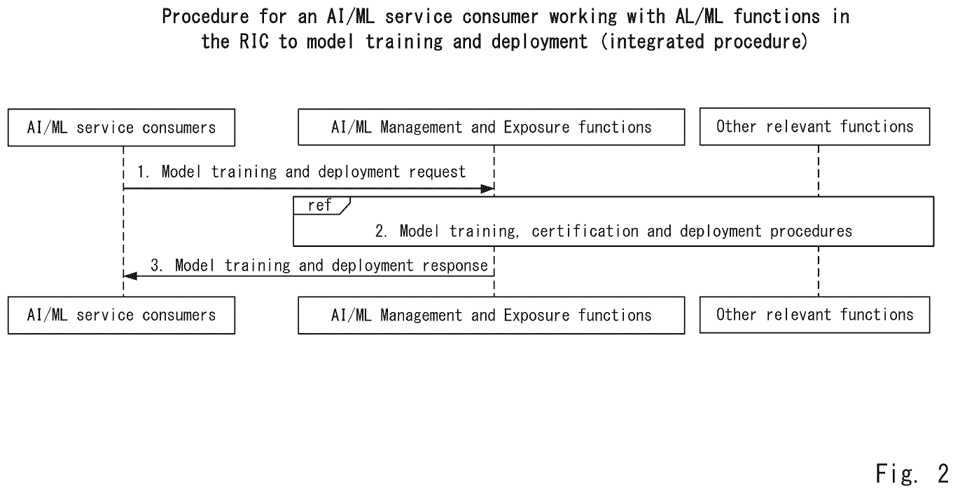

FIG. 2 illustrates schematically an exemplary procedure in accordance with Solution 2, and the procedure focuses on the interaction between an AI/ML service consumer and the AI/ML Management and Exposure functions. The procedure on the model training, certification and deployment procedures are disclosed in Solutions 3, 4, 5, and 6.

FIG. 2 demonstrates some exemplary procedures (in an integrated procedure) for an AI/ML service consumer working with AL/ML functions in the RIC to model training and deployment. The following steps are taken.
Step 1: In order to train and deploy an AI/ML model, the AI/ML service consumer (e.g. an operator) invokes an AI/ML model training and deployment request procedure or any other relevant procedure or sends an “AI/ML model training and deployment request” message or any other relevant message to the AI/ML management functions for requesting AI/ML model training and deployment.

The AI/ML service consumer can be the operator.

This message from the AI/ML service consumer to the AI/ML management functions includes any of the following parameters:
an AI/ML ID, which is used to identify the AI/ML model
Application type, which can be a xApp or a rApp
Application ID, which is used to identify the application.
Destination that hosts the target application, which can be Non-RT RIC or Near-RT RIC
New AI/ML model indicator, which is used to indicate that the related AI/ML is a new model
   AI/ML model ID if there is an existing AI/ML model.
Version number, which is used to indicate the version of AI/ML model
list of input parameters for model training, which indicate the data for model training
list of output parameters for model training, which indicate the data as the results of model training
performance criteria for model training, which is used to measure the performance of the model training
certification parameters, which is used for model certification
deployment parameters, which is used for model deployment

An example of input data for model training may include any of the following:
Measurement data from O-CU, O-DU, and O-RU
Analytical data from rApps
Analytical data from xApps
EI data from external sources
A combination of information listed above.

An example of output data for model training may include any of the following:
Analytical data from rApps
Analytical data from xApps
Accuracy of model training

An example of performance criteria for model training may include any of the following:
Accuracy threshold, which is used to indicate whether the accuracy of model training is successful or not
Execution time of AI/ML model

An example of certification parameters may include any of the following:
Deployment options
Configuration parameters
Certification environment
Runtime environment
Version number

An example of deployment parameters may include any of the following:
Deployment options
Application ID, which is used to identify the application.
Destination that host the target application, which can be Non-RT RIC or Near-RT RIC
Application type, which can be a xApp or a rApp
Target application ID
Resources related to each deployment option
Configuration parameters
Runtime environment
Version number

Different names can be used for the above parameters to serve the same and similar purpose.

The parameters can be sent to the AI/ML management functions in a separated message. Different names can be used for the above message to serve the same and similar purpose.
Step 2: The AI/ML management functions invoke an AI/ML model training and deployment request procedure or any other relevant procedure or send an “AI/ML model training and deployment request” message or any other relevant message to the related AI/ML functions to perform AI/ML model training, verification, registration, and deployment.

These related model training, verification, registration, deployment procedures are disclosed in Solutions 3, 4, 5 and 6.

The AI/ML management functions may send multiple messages to the involved AI/ML functions based on the training and deployment options provided by the AI/ML service consumer. Different names can be used for the above message to serve the same and similar purpose.
Step 3: Based on the results from AI/ML model training and deployment, the AI/ML management functions notify the relevant AI/ML service consumer(s) of the AI/ML model training and deployment result(s) by invoking an AI/ML model training and deployment response procedure or any other relevant procedure or send an “AI/ML model training and deployment response” message or any other message to the relevant service consumer (e.g. operator) in order to report/notify AI/ML model training and deployment result(s). This message includes the AI/ML model training and deployment result(s).

Different names can be used for the above messages to serve the same or a similar purpose.

### Solution 3: a Solution on How to Train an AI/ML Model in the RIC

The main idea of this solution is that the AI/ML Management and Exposure functions instructs the AI/ML model training functions to train the AI/ML model. AI/ML model training functions request the Data management and Exposure function to provide data. Based on the obtained data, the AI/ML model training functions performs model training, model evaluation and model validation. If the training is successful, the AI/ML model training functions store the AI/ML model at AI/ML model inventory and inform the AI/ML Management and Exposure functions.

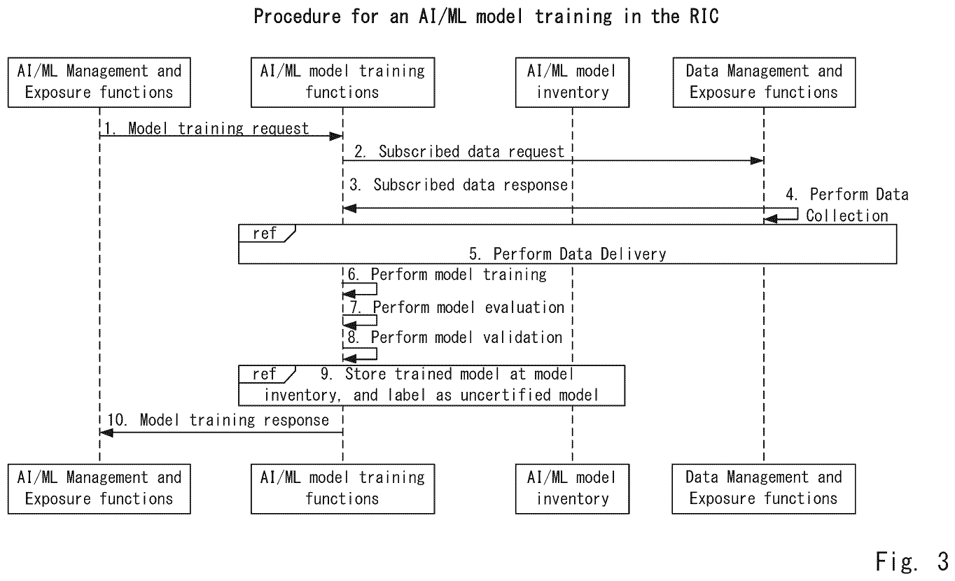

FIG. 3 illustrates schematically an exemplary procedure in accordance with Solution 3, and the procedure focuses on how to train an AI/ML model in the RIC.

Specifically, FIG. 3 demonstrates some exemplary procedures for an AI/ML model training in the RIC. The following steps are taken.
Step 1: In order to train an AI/ML model, the AI/ML management functions invoke an AI/ML model training request procedure or any other relevant procedure or send an “AI/ML model training request” message or any other relevant message to the AI/ML model training functions for requesting AI/ML model training.

This message from the AI/ML management functions to the AI/ML model training functions may include any of the following parameters:
an AI/ML ID, which is used to identify the AI/ML model
Application type, which can be a xApp or a rApp
Application ID, which is used to identify the application.
Destination that host the target application, which can be Non-RT RIC or Near-RT RIC
   New AI/ML model indicator, which is used to indicate that the related AI/ML is a new model.
AI/ML model ID if there is an existing AI/ML model
Version number, which is used to indicate the version of AI/ML model
list of input parameters for model training, which indicate the data for model training
list of output parameters for model training, which indicate the data as the results of model training.
performance criteria for model training, which is used to measure the performance of the model training

An example of input data for model training may include any of the following:
Measurement data from O-CU, O-DU, and O-RU
Analytical data from rApps
Analytical data from xApps
EI data from external sources
A combination of information listed above.

An example of output data for model training may include any of the following:
Analytical data from rApps
Analytical data from xApps
Accuracy of model training

An example of performance criteria for model training may include any of the following:
Accuracy threshold, which is used to indicate whether the accuracy of model training is successful or not
Execution time of AI/ML model

Different names can be used for the above parameters to serve the same and similar purpose.

It will be appreciated that the parameters can be sent to the AI/ML model training functions in separate messages.

The AI/ML management functions may send multiple messages to the AI/ML training functions based on the training options provided by the AI/ML service consumer. Different names can be used for the above message to serve the same and similar purpose.
Step 2: The AI/ML model training functions invoke a subscribed data request procedure or any other relevant procedure or send a “subscribed data request” message or any other relevant message to the Data Management and exposure functions for requesting data for model training.
Step 3: The Data Management and exposure functions respond with “subscribed data response” message or any other relevant message.
Step 4: The Data Management and exposure functions perform data collection based on AI/ML model training functions' request.
Step 5: The Data Management and exposure functions perform data delivery to provide the AI/ML model training functions with the data for model training.
Step 6: The AI/ML model training functions perform model training based on collected data and the requirements from the AI/ML management functions. The data can be split for model training, model evaluation and model validation.
Step 7: The AI/ML model training functions perform model evaluation.
Step 8: The AI/ML model training functions perform model validation.
Step 9: The AI/ML model training functions store the trained model at the model inventory, and labels it as an uncertified model.
Step 10: Based on the results from AI/ML model training, the AI/ML training functions notify the AI/ML management functions of the AI/ML model training result(s) by invoking an AI/ML model training response procedure or any other relevant procedure or send an “AI/ML model training response” message or any other message to AI/ML management functions in order to report/notify AI/ML model training result(s). This message includes the AI/ML model training result(s).

Different names can be used for the above messages to serve the same or a similar purpose.

### Solution 4: a Solution on How to Certify an AI/ML Model in the RIC

The main idea of this solution is that the AI/ML Management and Exposure functions instruct the AI/ML model certification functions to verify and certify the AI/ML model. The AI/ML Management and Exposure functions instruct the AI/ML model certification functions to certify AI/ML model.

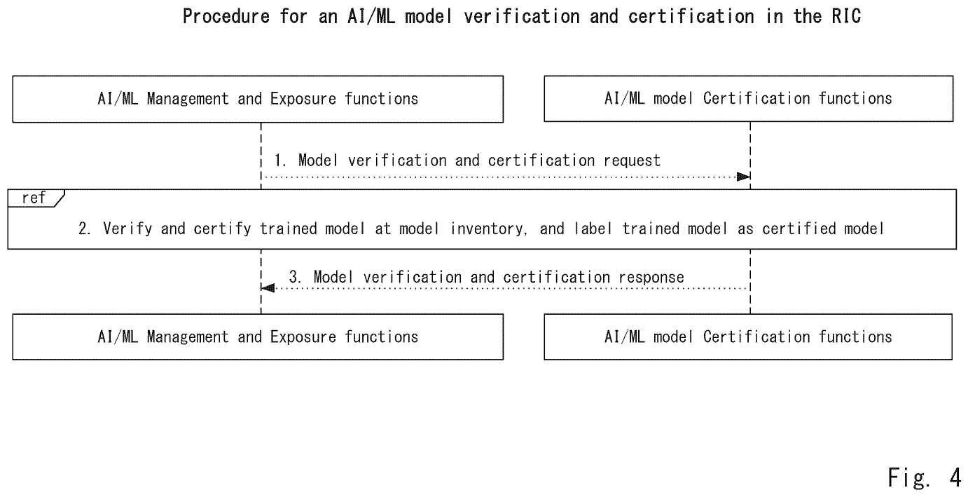

FIG. 4 illustrates schematically an exemplary procedure in accordance with Solution 4, and the procedure focuses on how to certify an AI/ML model in the RIC.

Specifically, FIG. 4 demonstrates some exemplary procedures for an AI/ML model verification and certification in the RIC. The following steps are taken.
Step 1: The AI/ML management functions invoke an AI/ML model verification and certification request procedure or any other relevant procedure or send an “AI/ML model verification and certification request” message or any other relevant message to the AI/ML model certification functions for requesting AI/ML model certification.

This message from the AI/ML management functions to the AI/ML model certification functions may include the following parameters:
an AI/ML ID, which is used to identify the AI/ML model.
Application type, which can be a xApp or a rApp
Application ID, which is used to identify the application.
Destination that host the target application, which can be Non-RT RIC or Near-RT RIC.
New AI/ML model indicator, which is used to indicate that the related AI/ML is a new model
AI/ML model ID if there is an existing AI/ML model.
Version number, which is used to indicate the version of AI/ML model
certification parameters, which is used for model certification

An example of certification parameters may include any of the following:
Deployment options
Configuration parameters
Certification environment
Runtime environment
Version number

Different names can be used for the above parameters to serve the same or a similar purpose.

The parameters can be sent to the AI/ML model certification functions in separate messages.

The AI/ML management functions may send multiple messages to the AI/ML model certification functions based on the certification requirements provided by the AI/ML service consumer.

Different names can be used for the above message to serve the same or a similar purpose.
Step 2: The AI/ML model certification functions verify and certify the trained model at model inventory, and label the trained model as certified model.
Step 3: Based on the results from AI/ML model certification, the AI/ML certification functions notify the AI/ML management functions of the AI/ML model certification result(s) by invoking an AI/ML model certification response procedure or any other relevant procedure or send an “AI/ML model certification response” message or any other message to the AI/ML management functions in order to report/notify AI/ML model certification result(s). This message includes the AI/ML model certification result(s). Different names can be used for the above message to serve the same or a similar purpose.

### Solution 5: a Solution on How to Register an AI/ML Model in the RIC

The main idea of this solution is that the AI/ML Management and Exposure functions instruct the AI/ML model registration functions to register the AI/ML model. The AI/ML Management and Exposure functions instruct the AI/ML model registration functions to register AI/ML model.

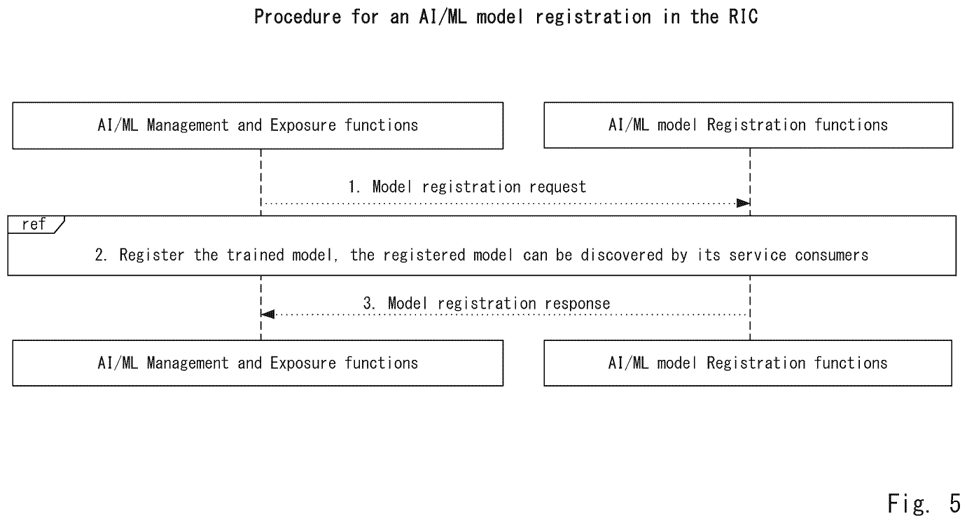

FIG. 5 illustrates schematically an exemplary procedure in accordance with Solution 5, and the procedure focuses on how to register an AI/ML model in the RIC.

Specifically, FIG. 5 demonstrates some exemplary procedures for an AI/ML model registration in the RIC. The following steps are taken.
Step 1: The AI/ML management functions invoke an AI/ML model registration request procedure or any other relevant procedure or send an “AI/ML model registration request” message or any other relevant message to the AI/ML model registration functions for requesting AI/ML model registration.

This message from the AI/ML management functions to the AI/ML model certification functions includes the following parameters:
an AI/ML ID, which is used to identify the AI/ML model
Application type, which can be a xApp or a rApp
Application ID, which is used to identify the application.
Destination that host the target application, which can be Non-RT RIC or Near-RT RIC
New AI/ML model indicator, which is used to indicate that the related AI/ML is a new model
AI/ML model ID if there is an existing AI/ML model
Version number, which is used to indicate the version of AI/ML model
list of input parameters for model training, which indicate the data for model training
list of output parameters for model training, which indicate the data as the results of model training
performance criteria for model training, which is used to measure the performance of the model training

An example of input data for model training may include any of the following:
Measurement data from O-CU, O-DU, and O-RU
Analytical data from rApps
Analytical data from xApps
EI data from external sources
A combination of information listed above.

An example of output data for model training may include any of the following:
Analytical data from rApps
Analytical data from xApps
Accuracy of model training

Different names can be used for the above parameters to serve the same or a similar purpose.

The parameters can be sent to the AI/ML model registration functions in separate messages.

The AI/ML management functions may send multiple messages to the AI/ML model registration functions.

Different names can be used for the above message to serve the same or a similar purpose.
Step 2: The AI/ML model registration functions register the trained model, the registered model can be discovered by its service consumers.
Step 3: Based on the results from AI/ML model registration, the AI/ML registration functions notify the AI/ML management functions of the AI/ML model registration result(s) by invoking an AI/ML model registration response procedure or any other relevant procedure or send an “AI/ML model registration response” message or any other message to the AI/ML management functions in order to report/notify AI/ML model registration result(s). This message includes the AI/ML model registration result(s).

Different names can be used for the above messages to serve the same or a similar purpose.

### Solution 6: a Solution on How to Deploy an AI/ML Model in the RIC

The main idea of this solution is that the AI/ML Management and Exposure functions instruct the AI/ML model deployment functions to deploy the AI/ML model. The AI/ML Management and Exposure functions instruct the AI/ML model deployment functions to deploy AI/ML model. The AI/ML model deployment functions instruct the Network Function Orchestrator to deploy the model on the O-cloud via the DMS. When the model is deployed and the AI/ML model inference can be performed on the target application, the Network Function Orchestrator notifies the AI/ML model deployment functions of the model deployment results, and the AI/ML model deployment functions inform the AI/ML Management and Exposure functions of the model deployment results.

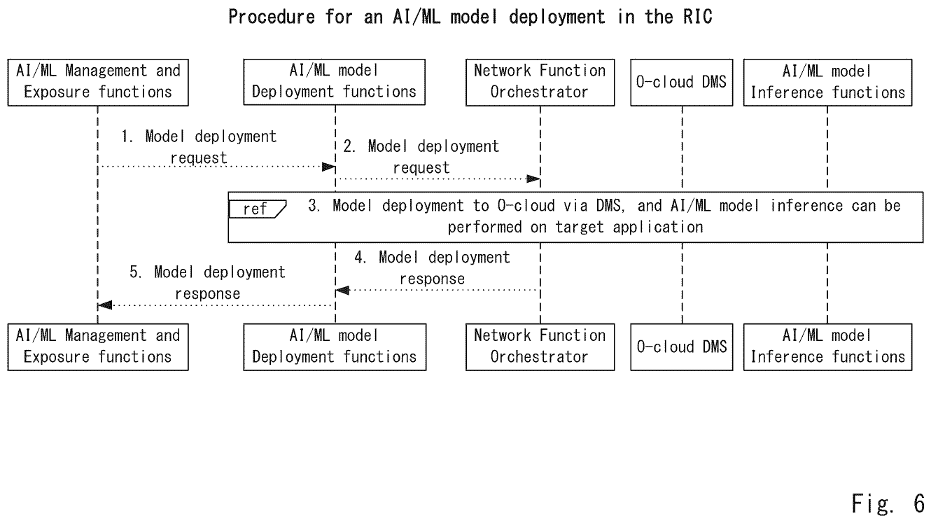

FIG. 6 illustrates schematically an exemplary procedure in accordance with Solution 6, and the procedure focuses on how to deploy an AI/ML model in the RIC.

Specifically, FIG. 6 demonstrates some exemplary procedures for an AI/ML model deployment in the RIC. The following steps are taken.
Step 1: The AI/ML management functions invoke an AI/ML model deployment request procedure or any other relevant procedure or send an “AI/ML model deployment request” message or any other relevant message to the AI/ML model deployment functions for requesting AI/ML model deployment.

This message from the AI/ML management functions to the AI/ML model deployment functions may include any of the following parameters:
an AI/ML ID, which is used to identify the AI/ML model
Application type, which can be a xApp or a rApp
Application ID, which is used to identify the application.
Destination that host the target application, which can be Non-RT RIC or Near-RT RIC
New AI/ML model indicator, which is used to indicate that the related AI/ML is a new model
AI/ML model ID if there is an existing AI/ML model
Version number, which is used to indicate the version of AI/ML model
deployment parameters, which is used for model deployment

An example of deployment parameters may include any of the following:
Deployment options
Application ID, which is used to identify the application
Destination that host the target application, which can be Non-RT RIC or Near-RT RIC
Application type, which can be a xApp or a rApp
Target application ID
Resources related to each deployment option
Configuration parameters
Runtime environment
Version number

Different names can be used for the above parameters to serve the same or a similar purpose.

The parameters can be sent the AI/ML model deployment functions in separate messages.

The AI/ML management functions may send multiple messages to the AI/ML model deployment functions.

Different names can be used for the above message to serve the same or a similar purpose.
Step 2: The AI/ML deployment functions invoke an AI/ML model deployment request procedure or any other relevant procedure or send an “AI/ML model deployment request” message or any other relevant message to the Network Function Orchestrator for requesting AI/ML model deployment.

This message from the AI/ML deployment functions to the Network Function Orchestrator may include any of the following parameters:
an AI/ML ID, which is used to identify the AI/ML model
Application type, which can be a xApp or a rApp
Application ID, which is used to identify the application.
Destination that host the target application, which can be Non-RT RIC or Near-RT RIC.
New AI/ML model indicator, which is used to indicate that the related AI/ML is a new model
AI/ML model ID if there is an existing AI/ML model
Version number, which is used to indicate the version of AI/ML model
deployment parameters, which is used for model deployment

An example of deployment parameters may include any of the following:
Deployment options
Application ID, which is used to identify the application.
Destination that host the target application, which can be Non-RT RIC or Near-RT RIC
Application type, which can be a xApp or a rApp
Target application ID
Resources related to each deployment option
Configuration parameters
Runtime environment
Version number

Different names can be used for the above parameters to serve the same or a similar purpose.

The parameters can be sent the Network Function Orchestrator in separate messages.

The AI/ML deployment functions may send multiple messages to the Network Function Orchestrator based on the training options.

Different names can be used for the above message to serve the same or a similar purpose.
Step 3: The Network Function Orchestrator perform model deployment to the O-cloud via DMS, and AI/ML model inference can be performed on target application.
Step 4: Based on the results from AI/ML model deployment, the Network Function Orchestrator notifies the AI/ML deployment functions of the AI/ML model deployment result(s) by invoking an AI/ML model deployment response procedure or any other relevant procedure or sends an “AI/ML model deployment response” message or any other message to the AI/ML deployment functions in order to report/notify AI/ML model deployment result(s). This message includes the AI/ML model deployment result(s).

Different names can be used for the above message to serve the same or a similar purpose.
Step 5: The AI/ML deployment functions notify the AI/ML management functions of the AI/ML model deployment result(s) by invoking an AI/ML model deployment response procedure or any other relevant procedure or send an “AI/ML model deployment response” message or any other message to the AI/ML management functions in order to report/notify AI/ML model deployment result(s). This message includes the AI/ML model deployment result(s).

Different names can be used for the above message to serve the same or a similar purpose.

### Solution 7: a Solution on How an AI/ML Service Consumer Works With AL/ML Functions in the RIC (in Separated Procedures)

The main idea of this solution is that an AI/ML service consumer requests the AI/ML Management and Exposure functions to perform AI/ML model training, certification, registration, and deployment. The AI/ML Management and Exposure functions instruct the related AI/ML functions to train, certify, register, and deploy AI/ML model in separated procedures. The AI/ML Management and Exposure functions inform an AI/ML service consumer of the AI/ML model training, certification, registration, and deployment result(s).

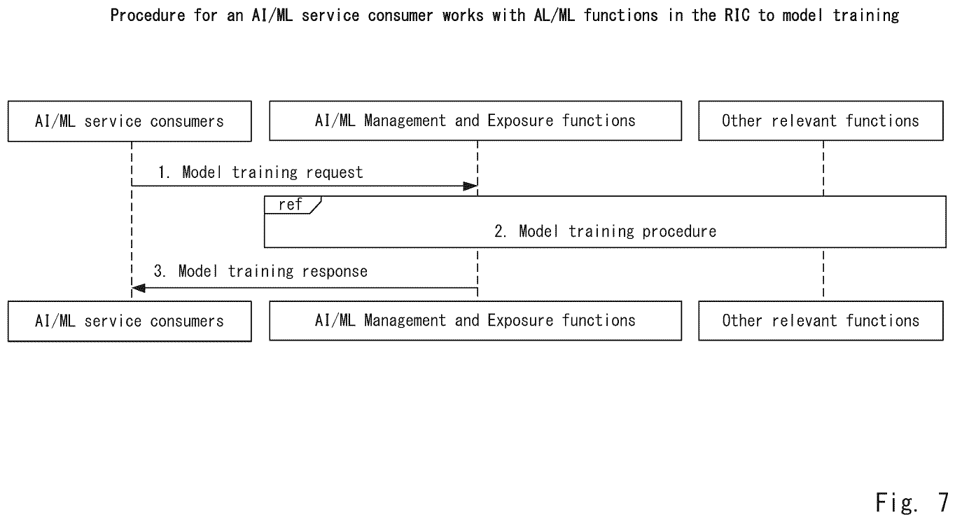

FIG. 7 illustrates schematically an exemplary procedure in accordance with Solution 7, and the procedure focuses on the interaction between an AI/ML service consumer and the AI/ML Management and Exposure functions.

Specifically, FIG. 7 demonstrates some exemplary procedures for an AI/ML service consumer works with AL/ML functions in the RIC to model training. The following steps are taken.
Step 1: In order to train an AI/ML model, the AI/ML service consumer (e.g. an operator) invokes an AI/ML model training request procedure or any other relevant procedure or sends an “AI/ML model training request” message or any other relevant message to the AI/ML management functions for requesting AI/ML model training.

The AI/ML service consumer can be the operator.

This message from the AI/ML service consumer to the AI/ML management functions may include the following parameters:
an AI/ML ID, which is used to identify the AI/ML model
Application type, which can be a xApp or a rApp
Application ID, which is used to identify the application.
Destination that hosts the target application, which can be Non-RT RIC or Near-RT RIC.
New AI/ML model indicator, which is used to indicate that the related AI/ML is a new model
AI/ML model ID if there is an existing AI/ML model
Version number, which is used to indicate the version of AI/ML model
list of input parameters for model training, which indicate the data for model training.
list of output parameters for model training, which indicate the data as the results of model training
performance criteria for model training, which is used to measure the performance of the model training

An example of input data for model training may include any of the following:
Measurement data from O-CU, O-DU, and O-RU
Analytical data from rApps
Analytical data from xApps
EI data from external sources
A combination of information listed above.

An example of output data for model training may include any of the following:
Analytical data from rApps
Analytical data from xApps
Accuracy of model training

An example of performance criteria for model training may include any of the following:
Accuracy threshold, which is used to indicate whether the accuracy of model training is successful or not
Execution time of AI/ML model

Different names can be used for the above parameters to serve the same or a similar purpose.

The parameters can be sent to the AI/ML management functions in separate messages.

Different names can be used for the above message to serve the same or a similar purpose.
Step 2: The AI/ML management functions invoke an AI/ML model training request procedure or any other relevant procedure or send an “AI/ML model training request” message or any other relevant message to the related AI/ML functions to perform AI/ML model training.

The AI/ML management functions may send multiple messages to the involved AI/ML functions based on the training options provided by the AI/ML service consumer.

Different names can be used for the above message to serve the same or a similar purpose.
Step 3: Based on the results from AI/ML model training, the AI/ML management functions notify the relevant AI/ML service consumer(s) of the AI/ML model training result(s) by invoking an AI/ML model training response procedure or any other relevant procedure or send an “AI/ML model training response” message or any other message to the relevant service consumer (e.g. operator) in order to report/notify AI/ML model training result(s). This message includes the AI/ML model training result(s).

Different names can be used for the above message to serve the same or a similar purpose.

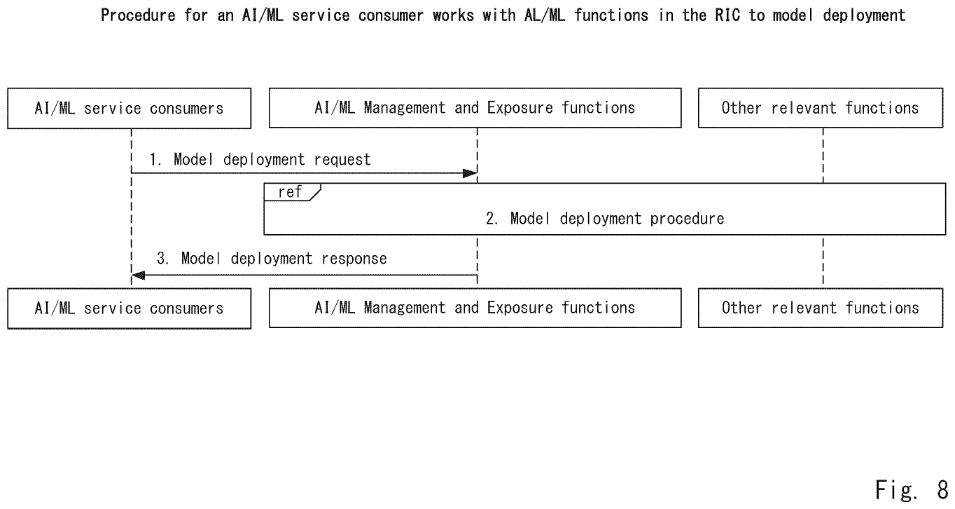

FIG. 8 illustrates schematically an exemplary procedure in accordance with Solution 7, and the procedure focuses on the interaction between an AI/ML service consumer and the AI/ML Management and Exposure functions.

Specifically, FIG. 8 demonstrates some exemplary procedures for an AI/ML service consumer works with AL/ML functions in the RIC to model deployment. The following steps are taken.
Step 1: In order to deploy an AI/ML model, the AI/ML service consumer (e.g. an operator) invokes an AI/ML model deployment request procedure or any other relevant procedure or send an “AI/ML model deployment request” message or any other relevant message to the AI/ML management functions for requesting AI/ML model deployment.

The AI/ML service consumer can be the operator.

This message from the AI/ML service consumer to the AI/ML management functions may include any of the following parameters:
an AI/ML ID, which is used to identify the AI/ML model
Application type, which can be a xApp or a rApp
Application ID, which is used to identify the application
Destination that host the target application, which can be Non-RT RIC or Near-RT RIC
New AI/ML model indicator, which is used to indicate that the related AI/ML is a new model
AI/ML model ID if there is an existing AI/ML model
Version number, which is used to indicate the version of AI/ML model
deployment parameters, which is used for model deployment

An example of deployment parameters may include any of the following:
Deployment options
Application ID, which is used to identify the application.
Destination that host the target application, which can be Non-RT RIC or Near-RT RIC
Application type, which can be a xApp or a rApp
Target application ID
Resources related to each deployment option
Configuration parameters
Runtime environment
Version number

Different names can be used for the above parameters to serve the same or a similar purpose.

The parameters can be sent to the AI/ML management functions in separate messages.

Different names can be used for the above message to serve the same or a similar purpose.
Step 2: The AI/ML management functions invoke an AI/ML model deployment request procedure or any other relevant procedure or send an “AI/ML model deployment request” message or any other relevant message to the related AI/ML functions to perform AI/ML model deployment.

The AI/ML management functions may send multiple messages to the involved AI/ML functions based on the deployment options provided by the AI/ML service consumer.

Different names can be used for the above message to serve the same or a similar purpose.
Step 3: Based on the results from AI/ML model deployment, the AI/ML management functions notify the relevant AI/ML service consumer(s) of the AI/ML model deployment result(s) by invoking an AI/ML model deployment response procedure or any other relevant procedure or send an “AI/ML model deployment response” message or any other message to the relevant service consumer (e.g. operator) in order to report/notify AI/ML model deployment result(s). This message includes the AI/ML model deployment result(s).

Different names can be used for the above message to serve the same or a similar purpose.

### SUMMARY

In summary therefore:
1) Currently, there is no specification of what AI/ML functions are needed, where are these AI/ML functions located and how to provide AI/ML functions in RIC. This document proposes a serviced-based AI/ML architecture, and the AI/ML functions. These AI/ML functions, namely AI/ML Management and Exposure functions, AI/ML model training functions, AI/ML model certification functions, AI/ML model registration functions, AI/ML model deployment functions, AI/ML model inference functions and AI/ML model Inventory, can provided all the key functions and services needed in ORAN. All these AI/ML functions are logical functions and can be merged according to an operator's need. The provided services can be produced by SMO/Non-RT RIC framework/Near-RT Framework, or applications, or hybrid among frameworks and applications. This design provides significant flexibility for operators to implement AI/ML in their networks.
2) Currently, there is no mechanism to provide key AI/ML features such as model training, certification and registration and deployment in RIC. This invention proposed five seamlessly integrated procedures to provide end-to-end solutions for AI/ML model training, certification, registration, and deployment.
3) A number of new parameters have been proposed to facilitate the AI/ML training, certification, registration, and deployment.

In order to provide the above functionalities, the present document describes the following examples:

A service-based AI/ML architecture, in a RIC, that comprises (at least some of) the following:
1) A serviced-based AI/ML architecture, which has a number of AI/ML functions, namely AI/ML Management and Exposure functions, AI/ML model training functions, AI/ML model certification functions, AI/ML model registration functions, AI/ML model deployment functions, AI/ML model inference functions and AI/ML model Inventory.
2) All these AI/ML functions are logical functions and can be merged according to an operator's need.
3) The provided services can be produced by SMO/Non-RT RIC framework/Near-RT Framework, or applications, or hybrid among frameworks and applications.

A solution for how an AI/ML service consumer works with AL/ML functions in the RIC, involving a method comprising (at least some of) the steps of:
1) An AI/ML service consumer requests the AI/ML Management and Exposure functions to perform AI/ML model training, certification, registration, and deployment.
2) The AI/ML management functions invoke an AI/ML model training and deployment request procedure and perform AI/ML model verification, registration, and deployment.

A solution for how to train an AI/ML model in the RIC, involving a method comprising (at least some of) the steps of:
1) The AI/ML Management and Exposure functions instruct the AI/ML model training functions to train the AI/ML model.
2) The AI/ML model training functions request the Data management and Exposure function to provide the data.
3) Based on the obtained data, the AI/ML model training functions performs model training, model evaluation and model validation.
4) The AI/ML model training functions store the AI/ML model at AI/ML model inventory and inform the AI/ML Management and Exposure functions.

A solution for how to certify an AI/ML model in the RIC, involving a method comprising (at least some of) the steps of:
1) The AI/ML Management and Exposure functions instruct the AI/ML model certification functions to verify and certify the AI/ML model.
2) The AI/ML model certification functions verify and certify trained model at model inventory, and label trained model as certified model.

A solution for how to register an AI/ML model in the RIC, involving a method comprising (at least some of) the steps of:
1) The AI/ML Management and Exposure functions instruct the AI/ML model registration functions to register the AI/ML model.
2) The AI/ML model registration functions register the trained model, the registered model can be discovered by its service consumers.

A solution for how to deploy an AI/ML model in the RIC, involving a method comprising (at least some of) the steps of:
1) The AI/ML Management and Exposure functions instruct the AI/ML model deployment functions to deploy AI/ML model.
2) The AI/ML model deployment functions instruct the Network Function Orchestrator to deploy the model on the O-cloud via the DMS.
3) The model is deployed and the AI/ML model inference can be performed on the target application.

Currently, there is no specification on what AI/ML functions are needed, where these AI/ML functions are located and how to provide AI/ML functions in RIC. It can be seen that the above solutions propose a serviced-based AI/ML architecture, and the AI/ML functions. The proposed AI/ML functions can be provided all the key functions and services needed in ORAN. All these AI/ML functions are logical functions and can be merged according to an operator's need. The provided services can be produced among frameworks and/or applications. This design provides significant flexibility for operators to implement AI/ML in their networks.

Currently, there is no mechanism to provide key AI/ML features such as model training, certification and registration and deployment in RIC. Novel end-to-end solutions are proposed to train, verify, register, and deploy AI/ML models in a RAN intelligent Controller.

### System Overview

FIG. 9 schematically illustrates a mobile (cellular or wireless) telecommunication system 1 to which the above aspects are applicable.

In this network, users of mobile devices 3 (UEs) can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst one mobile device 3 and one base station 5 (RAN) are shown in FIG. 9 for illustration purposes, the system, when implemented, will typically include other base stations and mobile devices (UEs).

Each base station 5 controls one or more associated cells (either directly or via other nodes such as home base stations, relays, remote radio heads, distributed units, and/or the like). A base station 5 that supports E-UTRA protocols to the mobile devices 3 may be referred to as an ‘ng-eNB’ and a base station 5 that supports Next Generation protocols to the mobile devices 3 may be referred to as a ‘gNB’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘Uu’ interface, ‘NR’ air interface, and/or the like). Neighbouring base stations 5 are connected to each other via an appropriate base station to base station interface (such as the so-called ‘X2’ interface, ‘Xn’ interface and/or the like). The base station 5/access network is also connected to the core network nodes via an appropriate interface (such as the so-called ‘NG-U’ interface (for user-plane), the so-called ‘NG-C’ interface (for control-plane), and/or the like).

The core network 7 typically includes logical nodes (or ‘functions’) for supporting communication in the telecommunication system 1. Typically, for example, the core network 7 of a ‘Next Generation’ /5G system will include, amongst other functions, user plane functions (UPFs) 10 and control plane functions (CPFs) 11. The so-called artificial intelligence/machine learning (AI/ML) function 12 may also be provided in the core network 7 or in a node coupled to the core network 7.

It will be appreciated that the core network 7 may also include, amongst others: an Access and Mobility Management Function (AMF), a Session Management Function (SMF), a Unified Data Management (UDM)/Unified Data Repository (UDR) function, and a Policy Control Function (PCF). Although not shown in FIG. 9, the core network 7 may also be coupled to at least one application function (AF)/application server (AS), and/or the like.

From the core network 7, connection to an external IP network/data network 20 (such as the Internet) is also provided.

The components of this system 1 are configured to perform one or more of the above described solutions.

### User Equipment (UE)

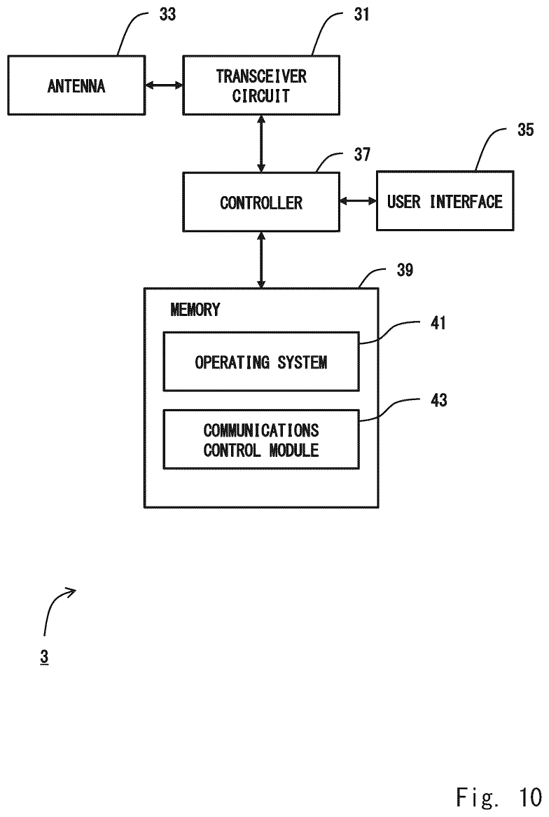

FIG. 10 is a block diagram illustrating the main components of the UE (mobile device 3) shown in FIG. 9. As shown, the UE includes a transceiver circuit 31 which is operable to transmit signals to and to receive signals from the connected node(s) via one or more antenna 33. Although not necessarily shown in FIG. 10, the UE will of course have all the usual functionality of a conventional mobile device (such as a user interface 35) and this may be provided by any one or any combination of hardware, software, and firmware, as appropriate. A controller 37 controls the operation of the UE in accordance with software stored in a memory 39. The software may be pre-installed in the memory 39 and/or may be downloaded via the telecommunication network 1 or from a removable data storage device (RMD), for example. The software includes, among other things, an operating system 41 and a communications control module 43. The communications control module 43 is responsible for handling (generating/sending/receiving) signaling messages and uplink/downlink data packets between the UE 3 and other nodes, including (R)AN nodes 5, application functions, and core network nodes. Such signalling includes appropriately formatted requests and responses relating to AI&ML model training, verification, registration, and deployment.

### (R)AN Node

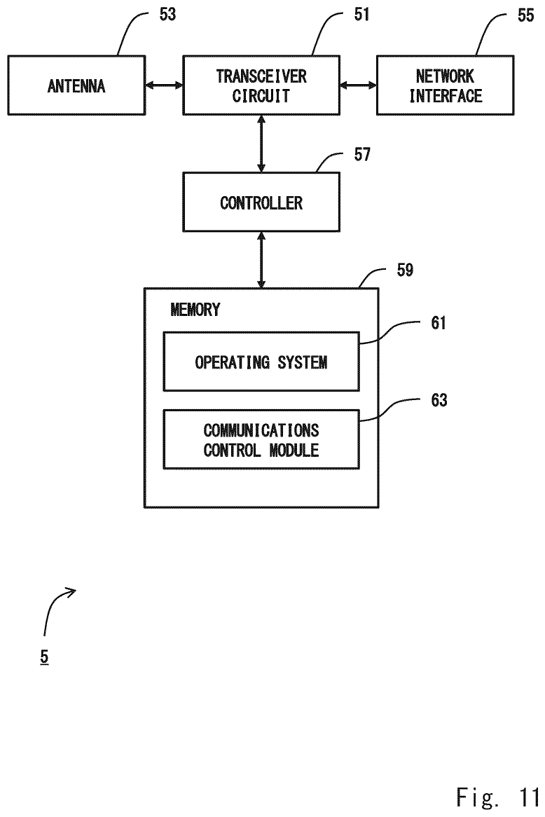

FIG. 11 is a block diagram illustrating the main components of an exemplary (R)AN node 5 (base station) shown in FIG. 9. As shown, the (R)AN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as NG-U/NG-C). A controller 57 controls the operation of the (R)AN node 5 in accordance with software stored in a memory 59. The software may be pre-installed in the memory 59 and/or may be downloaded via the telecommunication network 1 or from a removable data storage device (RMD), for example. The software includes, among other things, an operating system 61 and a communications control module 63. The communications control module 63 is responsible for handling (generating/sending/receiving) signaling between the (R)AN node 5 and other nodes, such as the UE 3, and the core network nodes. Such signalling includes appropriately formatted requests and responses relating to AI&ML model training, verification, registration, and deployment.

### Core Network Node

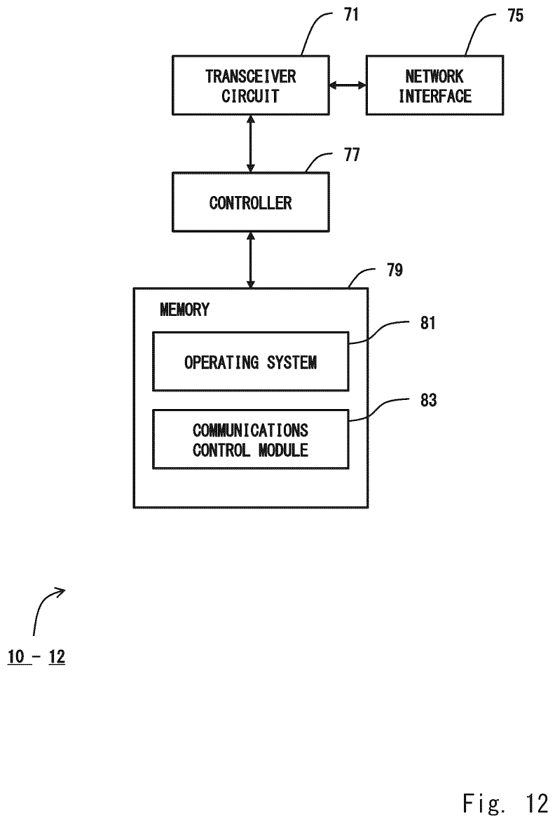

FIG. 12 is a block diagram illustrating the main components of a generic core network node (or function) shown in FIG. 9, for example, the UPF 10, the CPF 11, and the AI/ML function 12. As shown, the core network node includes a transceiver circuit 71 which is operable to transmit signals to and to receive signals from other nodes (including the UE 3 and the (R)AN node 5) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81 and at least a communications control module 83. The communications control module 83 is responsible for handling (generating/sending/receiving) signalling between the core network node and other nodes, such as the UE 3, (R)AN node 5, and other core network nodes. Such signalling includes appropriately formatted requests and responses relating to AI&ML model training, verification, registration, and deployment.

### Modifications and Alternatives

Detailed aspects have been described above. As those skilled in the art will appreciate, a number of modifications and alternatives can be made to the above aspects whilst still benefiting from the inventions embodied therein. By way of illustration only a number of these alternatives and modifications will now be described.

In the above description, the UE, the (R)AN node, and the core network node (AI/NL function) are described for ease of understanding as having a number of discrete modules (such as the communication control modules). Whilst these modules may be provided in this way for certain applications, for example where an existing system has been modified to implement the above aspects, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part, or all of this software may be performed using one or more dedicated hardware circuits. However, the use of software modules is preferred as it facilitates the updating of the UE, the (R)AN node, and the core network node (AI/ML function) in order to update their functionalities.

The above aspects are also applicable to ‘non-mobile’ or generally stationary user equipment.

Various other modifications will be apparent to those skilled in the art and will not be described in further detail here.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A system for supporting artificial intelligence/machine learning (AI/ML) model functions using a service-based architecture in a radio access network (RAN) intelligent controller (RIC), the system comprising:
a first function for managing AI/ML functions, and for exposing management and exposure services for the AI/ML functions;
a second function for providing services for deploying the AI/ML models in the at least one RIC: and
a repository for storing the AI/ML models,
wherein the first function, the second function, and the repository are connected with the service-based architecture.

2. The system according to claim 1, further comprising at least one of:
a third function for providing services for training the AI/ML models;
a fourth function for providing services for certifying the AI/ML models;
a fifth function for providing services for registering the AI/ML models;
a sixth function for providing services for performing AI/ML model inference using the an AI/ML model; and/or
a seventh function for providing data management services for training the AI/ML models.

3. (canceled)

4. A method of providing AI/ML services to a service consumer using the system of claim 1, the method comprising:
receiving, from a service consumer, a message for requesting the first function to perform at least one of: model training; certification; registration; and/or deployment for an AI/ML model; and
initiating, by the first function, a procedure to perform the at least one of: model training; certification; registration; and/or deployment for the AI/ML model.

5. The method according to claim 4, wherein the message, is for requesting to perform the model training and includes:
a parameter indicating an AI/ML identity (ID) for identifying the AI/ML model;
a parameter indicating an application type;
a parameter indicating an application identity for identifying an application;
a parameter indicating a destination that hosts a target application;
a parameter indicating that the AI/ML model is a new AI/ML model;
a parameter indicating an existing AI/ML model identity (ID) in a case where there is an existing AI/ML model;
a parameter indicating a version number for indicating a version of the AI/ML model; and
a list of input parameters for model training for indicating input data for training the AI/ML model;
a list of output parameters for model training for indicating output data for AI/ML model training for AI/ML model training; and/or
at least one parameter indicating a performance criteria for model training for use in measuring a performance of the model training.

6. The method according to claim 5, wherein the parameter indicating the application type indicates the application type to be a non-real-time RIC (Non-RT RIC) application (rApp) or a near-real-time RIC (Near-RT RIC) application (xApp).

7. The method according to claim 5, wherein the parameter indicating the destination indicates the destination to be a non-real-time RIC (Non-RT RIC) or a near-real-time RIC (Near-RT RIC).

8. The method according to claim 5, wherein the input data for training the AI/ML model includes at least one of the following:
measurement data from an open radio access network (O-RAN) central unit (OCU), an O-RAN distributed unit (O-DU), and/or an open RAN remote unite (O-RU);
analytical data from at least one non-real-time RIC (Non-RT RIC) application (rApp);
analytical data from at least one near-real-time RIC (Near-RT RIC) application (xApp); and/or
enrichment information (EI) data from at least one external source.

9. The method according to claim 5, wherein the output data for AI/ML model training includes at least one of the following:
analytical data from at least one non-real-time RIC (Non-RT RIC) application (rApp);
analytical data from at least one near-real-time RIC (Near-RT RIC) application (xApp); and/or
data indicating an accuracy of model training.

10. The method according to claim 5, wherein the performance criteria for model training includes at least one of the following:
an accuracy threshold for indicating whether or not a target accuracy for model training has been successfully achieved; and/or
an execution time for the trained AI/ML model.

11-12. (canceled)

13. The method according to claim 4, wherein the message is for requesting at least AI/ML model deployment and includes:
a parameter indicating an AI/ML identity (ID) for identifying the AI/ML model;
a parameter indicating an application type;
a parameter indicating an application identity for identifying an application;
a parameter indicating a destination that hosts a target application;
a parameter indicating that the AI/ML model is a new AI/ML model;
a parameter indicating an existing AI/ML model identity (ID) in a case where there is an existing AI/ML model;
a parameter indicating a version number for indicating a version of the AI/ML model; and/or
at least one deployment parameter for use in model deployment.

14. The method according to claim 13, wherein the at least one deployment parameter includes at least one of the following:
at least one parameter indicating at least one deployment option;
the parameter indicating the application identity for identifying the application;
a parameter indicating the destination that hosts the target application;
a parameter indicating an application type;
a parameter indicating a target application identity (ID);
at least one parameter indicating required resources related to each deployment option;
at least one configuration parameter;
at least one parameter indicating a runtime environment; and/or
at least one parameter indicating a version number.

15-18. (canceled)

19. A method of training an AI/ML model in a radio access network (RAN) intelligent controller (RIC), using the system of claim 2 in a case where the system includes the third function and the seventh at least one-function, the method comprising:
the first function instructing the third function to train the AI/ML model;
the third function requesting the seventh function to provide data to train the AI/ML model;
the third function receiving, from the seventh function, the data to train the AI/ML model; and
the third function performing model training for the AI/ML model based on the data, storing the trained AI/ML model at the -repository, and informing the first function.

20. The method according to claim 19, wherein the first function instructs the third function to train the AI/ML model using a message that includes at least one of:
a parameter indicating an AI/ML identity (ID) for identifying the AI/ML model;
a parameter indicating an application type;
a parameter indicating an application identity for identifying an application;
a parameter indicating a destination that hosts a target application;
a parameter indicating that the AI/ML model is a new AI/ML model;
a parameter indicating an existing AI/ML model identity (ID) in a case where there is an existing AI/ML model;
a parameter indicating a version number for indicating a version of the AI/ML model; and
a list of input parameters for model training for indicating input data for training the AI/ML model;
a list of output parameters for model training for indicating output data for AI/ML model training; and/or
at least one parameter indicating a performance criteria for model training for use in measuring a performance of the model training.

21-27. (canceled)

28. The method according to claim 19, wherein the third function performs evaluation and validation of the trained AI/ML model prior to storing the trained AI/ML model at the repository.

29. A method of certifying an AI/ML model in a radio access network (RAN) intelligent controller (RIC), using the system of claim 2 in a case where the system includes the fourth function, the method comprising:
the first function instructing the fourth function to verify and certify a trained AI/ML model stored at the repository;
the fourth function verifying and certifying the trained AI/ML model stored at the repository and labelling the trained AI/ML model as a certified model.

30. The method according to claim 29, wherein the first function instructs the fourth function to verify and certify the trained AI/ML model using a message including at least one of:
a parameter indicating an AI/ML identity (ID) for identifying the AI/ML model;
a parameter indicating an application type;
a parameter indicating an application identity for identifying an application;
a parameter indicating a destination that hosts a target application;
a parameter indicating that the AI/ML model is a new AI/ML model;
a parameter indicating an existing AI/ML model identity (ID) in a case where there is an existing AI/ML model;
a parameter indicating a version number for indicating a version of the AI/ML model; and/or
at least one certification parameter for use in model certification.

31-36. (canceled)

37. A method of registering an AI/ML model in a radio access network (RAN) intelligent controller (RIC), using the system of claim 2 in a case where the system includes the fifth function, the method comprising:
the first function instructing the fifth function to register a trained AI/ML model; and
the fifth function registering the trained AI/ML model for discovery by a service consumer.

38. The method according to claim 37, the first function instructs the fifth function to register the trained AI/ML model using a message including at least one of:
a parameter indicating an AI/ML identity (ID) for identifying the AI/ML model;
a parameter indicating an application type;
a parameter indicating an application identity for identifying an application;
a parameter indicating a destination that hosts a target application;
a parameter indicating that the AI/ML model is a new AI/ML model;
a parameter indicating an existing AI/ML model identity (ID) in a case where there is an existing AI/ML model;
a parameter indicating a version number for indicating a version of the AI/ML model; and
a list of input parameters for model training for indicating input data for training the AI/ML model;
a list of output parameters for model training for indicating output data for AI/ML model training; and/or
at least one parameter indicating a performance criteria for model training for use in measuring a performance of the model training.

39-44. (canceled)

45. A method of deploying an AI/ML model in a radio access network (RAN) intelligent controller (RIC), using the system of claim 1, the method comprising:
the first function instructing the second function to deploy an AI/ML model; and
the second function instructing a network function orchestrator to deploy the AI/ML model, whereby the network function orchestrator deploys the AI/ML model on an open-cloud.

46. The method according to claim 45, the first function instructs the second function to deploy the AI/ML model using a message including at least one of the following:
a parameter indicating an AI/ML identity (ID) for identifying the AI/ML model;
a parameter indicating an application type;
a parameter indicating an application identity for identifying an application;
a parameter indicating a destination that hosts a target application;
a parameter indicating that the AI/ML model is a new AI/ML model;
a parameter indicating an existing AI/ML model identity (ID) in a case where there is an existing AI/ML model;
a parameter indicating a version number for indicating a version of the AI/ML model; and/or
at least one deployment parameter for use in model deployment.

47-52. (canceled)
